(19) United States
(12) Patent Application Publication
(10) Pub. No.: US 2008/0291704 A1
(43) Pub. Date: Nov. 27, 2008

(54) DRIVING DEVICE AND METHOD FOR PROVIDING AN AC DRIVING SIGNAL TO A LOAD

(76) Inventors: Hong-Fei CHEN, Taichung City (TW); Leo LAI, Taichung (TW)

Correspondence Address: LADAS & PARRY LLP, 224 SOUTH MICHIGAN AVENUE, SUITE 1600, CHICAGO, IL, 60604, US

(21) Appl. No.: 12/123,556

(22) Filed: May 20, 2008

(30) Foreign Application Priority Data
May 23, 2007 (TW) 096118365

(51) Int. Cl. H02M 5/458

(52) U.S. Cl. 363/37

(57) ABSTRACT

In a driving device and method for providing an AC driving signal to a load, a first voltage converting unit converts an external AC voltage signal into a DC voltage signal using pulse width modulation in response to a feedback signal that is generated by a summing unit based on a standard voltage signal generated by a voltage detecting unit from the DC voltage signal, and a current detecting signal corresponding to a current flowing through the load and generated by a current detecting unit. A second voltage converting unit converts the DC voltage signal from the first voltage converting unit into the AC driving signal based on an external burst signal, and outputs the AC driving signal to the load.

### CROSS-REFERENCE TO RELATED APPLICATION

This application claims priority of Taiwanese Application No. 096118365, filed on May 23, 2007.

### BACKGROUND OF THE INVENTION

1. Field of the Invention

The invention relates to a driving device and method, more particularly to a driving device and method for providing an AC driving signal to a load.

2. Description of the Related Art

Referring to FIG. 1, a conventional driving device for providing an AC driving signal to a discharge tube 17 is shown to include a first voltage converting unit 11, a voltage detecting unit 12, a second voltage converting unit 13, and a current detecting unit 15.

The first voltage converting unit 11 converts an AC voltage signal, such as an AC voltage of 90V˜260V, from an AC power source 18 into a DC voltage signal, such as a DC voltage of 380V, using pulse width modulation in response to a standard voltage signal related to the DC voltage signal generated thereby, and outputs the DC voltage signal. The first voltage converting unit 11 includes: a first rectifying and filtering circuit having a full-bridge rectifier 111 and a capacitor 112, and coupled to the AC power source 18 for rectifying and filtering the AC voltage signal therefrom; a step-up transformer 113 having two windings 1131, 1132, wherein the winding 1131 is coupled to the first rectifying and filtering circuit for boosting the output voltage signal therefrom; a second rectifying and filtering circuit having a diode 116 and a capacitor 117, coupled to the winding 1131 of the step-up transformer 113 for rectifying and filtering the output voltage signal boosted thereby to output the DC voltage signal; a series connection of a switch 114 and a resistor 115 coupled to the winding 1131 of the step-up transformer 113; a voltage dividing circuit 118 coupled to the first rectifying and filtering circuit for generating a first reference voltage signal based on the output voltage signal from the first rectifying and filtering circuit; and a correction modulating unit 119 coupled to the voltage dividing circuit 118 and the winding 1132 of the step-up transformer 113 for receiving the first reference voltage signal and an induced voltage signal therefrom, and generating a control signal for controlling operation of the switch 114 based on the first reference voltage signal from the voltage dividing circuit 118, the induced voltage signal from the winding 1132 of the step-up transformer 113, a standard voltage signal related to the DC voltage signal, and a second reference voltage signal corresponding to a current flowing through the resistor 115. The control signal is generated in a discrete current mode using pulse width modulation so that the AC voltage signal and a current from the AC power source 18 are in phase, thereby correcting power factor. In operation, upon detecting that a current flowing through the winding 1131 of the step-up transformer 113 is equal to zero, the switch 114 is switched on through the control signal. Upon detecting that a voltage value of the second reference voltage signal is equal to a voltage value of the first reference signal multiplied by a voltage value of the standard voltage signal, the switch 114 is switched off through the control signal. As a result, the DC voltage signal outputted by the first voltage converting unit 11 is stable.

The voltage detecting unit 12 is coupled to the first voltage converting unit 11 for detecting the DC voltage signal therefrom, and outputs the standard voltage signal based on the DC voltage signal detected thereby.

The current detecting unit 15 is coupled to the discharge tube 17 and the second voltage converting unit 13 for detecting a current flowing through the discharge tube 17, and outputs a current detecting signal corresponding to the current flowing through the discharge tube 17.

The second voltage converting unit 13 is coupled to the first voltage converting unit 11 and the current detecting unit 15, converts the DC voltage signal from the first voltage converting unit 11 into the AC driving signal based on the current detecting signal from the current detecting unit 15, and outputs the AC driving signal to the discharge tube 17 based on an external burst signal. More specifically, the second voltage converting unit 13 includes a control unit 131, a half-bridge circuit 132, and a step-up transformer 140. The step-up transformer 140 has a primary winding 141 coupled to the half-bridge circuit 132, and a secondary winding 142 coupled to the discharge tube 17. The half-bridge circuit 132 includes four diodes 133, 134, 135, 136, first and second switches 137, 138, and a capacitor 139. The diode 133 has an anode coupled to the first voltage converting unit 11 and a cathode of the diode 135, and a cathode coupled to anodes of the diodes 135, 136, a cathode of the diode 136, and one end of the capacitor 139 through the first switch 137. A cathode of the diode 138 is coupled to ground through the second switch 138. An anode of the diode 136 is grounded. The primary winding 141 of the step-up transformer 140 is coupled between the other end of the capacitor 139 and ground. The control unit 131 is coupled to the first and second switches 137, 138, and the current detecting unit 15, generates first and second control signals, as shown in FIGS. 2a and 2b, for controlling respectively the first and second switches 137, 138 using pulse width modulation in response to the current detecting signal from the current detecting unit 15, and outputs respectively the first and second control signals to the first and second switches 137, 138 based on the burst signal, as shown in FIG. 3a, so that the AC driving signal converted from the DC voltage signal from the first voltage converting unit 11 is outputted to the discharge tube 17.

The first switch 137 is switched on during high-level periods of FIG. 2a, and the second switch 138 is switched on during high-level periods of FIG. 2b. The first control signal has a fixed pulse width such that the first switch 137 has a duty ratio substantially equal to 50%, while the second control signal has a modulated pulse width so that the second switch 138 has a duty ratio less than 40%, thereby influencing the current flowing through the discharge tube 17. The control unit 131 outputs the first and second control signals during high-level periods of FIG. 3a such that the AC driving signal converted from the DC voltage signal from the first voltage converting unit 11 is outputted to the discharge tube 17 during the high-level periods of FIG. 3a. Thus, the current flowing through the discharge tube 17 is obtained as shown in FIG. 3b, wherein the amplitude of the current is gradually increased to a stable value, thereby preventing overshooting. It is noted that an average value of the current flowing through the discharge tube 17 is determined based on the duty ratio of the second switch 138, i.e., the second control signal, and the burst signal. Thus, luminance of the discharge tube 17 can be adjusted, thereby attaining a dimming effect.

However, during a period (T) of FIGS. 2a and 2b, both the first and second switches 137, 138 are switched off such that currents flowing through the diodes 135, 136 may result in damage to the diodes 135, 136 due to heat generated by themselves. Furthermore, due to the heat generated by the diodes 135, 136, energy utilization efficiency is decreased.

Moreover, since the discharge tube 17 deteriorates after a period of use, to maintain a fixed luminance of the discharge tube 17, the duty ratio of the second switch 138 is designed to be smaller to increase the amplitude of the current flowing through the discharge tube 17. As a result, the period (T) as shown in FIGS. 2a and 2b becomes longer such that the aforesaid problems become more apparent.

### SUMMARY OF THE INVENTION

Therefore, an object of the present invention is to provide a driving device and method for providing an AC driving signal to a load that can overcome the aforesaid drawbacks of the prior art.

According to one aspect of the present invention, there is provided a driving device adapted for providing an AC driving signal to a load. The driving device comprises:

a first voltage converting unit adapted for converting an AC voltage signal from an external AC power source into a DC voltage signal using pulse width modulation in response to a feedback signal related to the AC driving signal, and outputting the DC voltage signal;

a voltage detecting unit coupled to the first voltage converting unit for detecting the DC voltage signal therefrom, and outputting a standard voltage signal based on the DC voltage signal detected thereby;

a second voltage converting unit coupled to the first voltage converting unit for converting the DC voltage signal therefrom into the AC driving signal based on an external burst signal, and adapted to output the AC driving signal to the load;

a current detecting unit adapted to be coupled to the load for detecting a current flowing through the load, and outputting a current detecting signal corresponding to the current flowing through the load; and

a summing unit coupled to the first voltage converting unit, the voltage detecting unit, and the current detecting unit, receiving the standard voltage signal from the voltage detecting unit and the current detecting signal from the current detecting unit, and outputting the feedback signal based on the standard voltage signal and the current detecting signal received thereby.

According to another aspect of the present invention, there is provided a method of providing an AC driving signal to a load. The method comprises the steps of:

a) generating a current detecting signal corresponding to a current flowing through the load;

b) generating a feedback signal based on the current detecting signal and a standard voltage signal;

c) converting an external AC voltage signal into a DC voltage signal using pulse width modulation in response to the feedback signal, the standard voltage signal being associated with the DC voltage signal; and

d) converting the DC voltage signal into the AC driving signal based on an external burst signal, and supplying the AC driving signal to the load.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic electrical circuit block diagram of a conventional driving device for driving a discharge tube;

FIGS. 2a and 2b are timing diagrams of exemplary first and second control signals for controlling first and second switches of a second voltage converting unit of the conventional driving device;

FIG. 3a is a timing diagram of an exemplary external burst signal applied to the second voltage converting unit of the conventional driving device;

FIG. 3b is a plot illustrating an exemplary current flowing through the discharge tube;

FIG. 4 is a schematic electrical circuit block diagram illustrating the preferred embodiment of a driving device for providing an AC driving signal to a load according to the present invention;

FIGS. 5a and 5b are timing diagrams of an exemplary first and second control signals for controlling first and second switches of a second voltage converting unit of the preferred embodiment;

FIG. 6a is a timing diagram of an exemplary external burst signal applied to the second voltage converting unit of the preferred embodiment;

FIG. 6b is a plot illustrating an exemplary current flowing through the load;

FIG. 6c is a plot illustrating an exemplary DC voltage signal outputted by a first voltage converting unit of the preferred embodiment; and

FIG. 7 is a schematic electrical circuit diagram illustrating a summing unit of the preferred embodiment.

### DETAILED DESCRIPTION OF THE PREFERRED EMBODIMENT

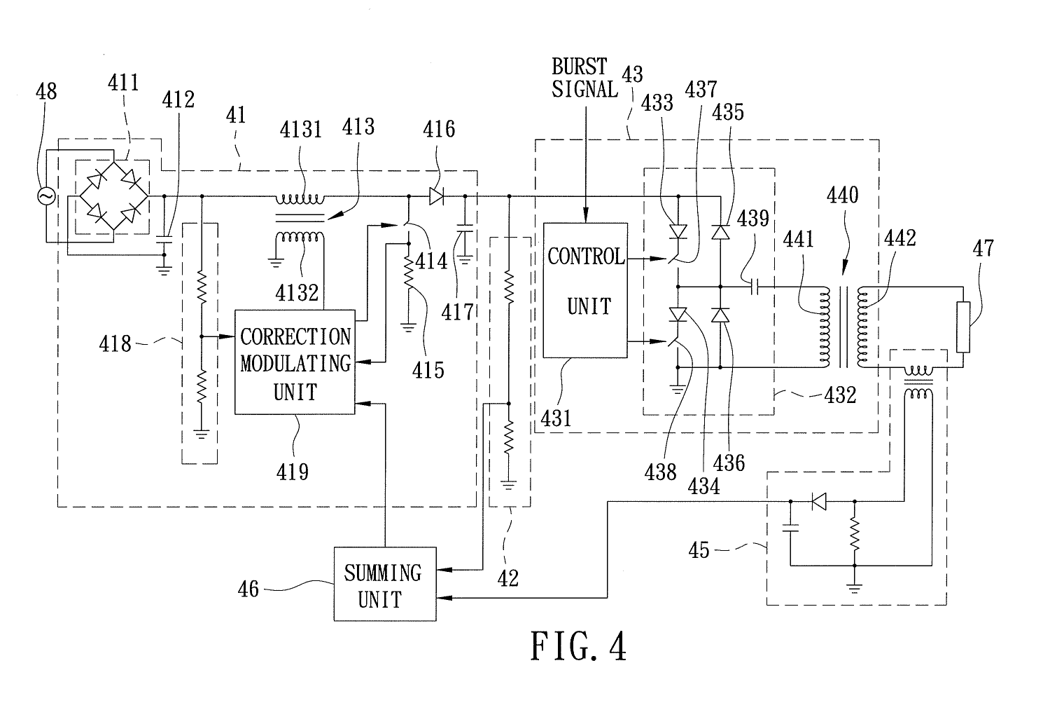

Referring to FIG. 4, the preferred embodiment of a driving device adapted for providing an AC driving signal to at least one load 47, such as a discharge tube, according to the present invention is shown to include a first voltage converting unit 41, a voltage detecting unit 42, a second voltage converting unit 43, a current detecting unit 45, and a summing unit 46.

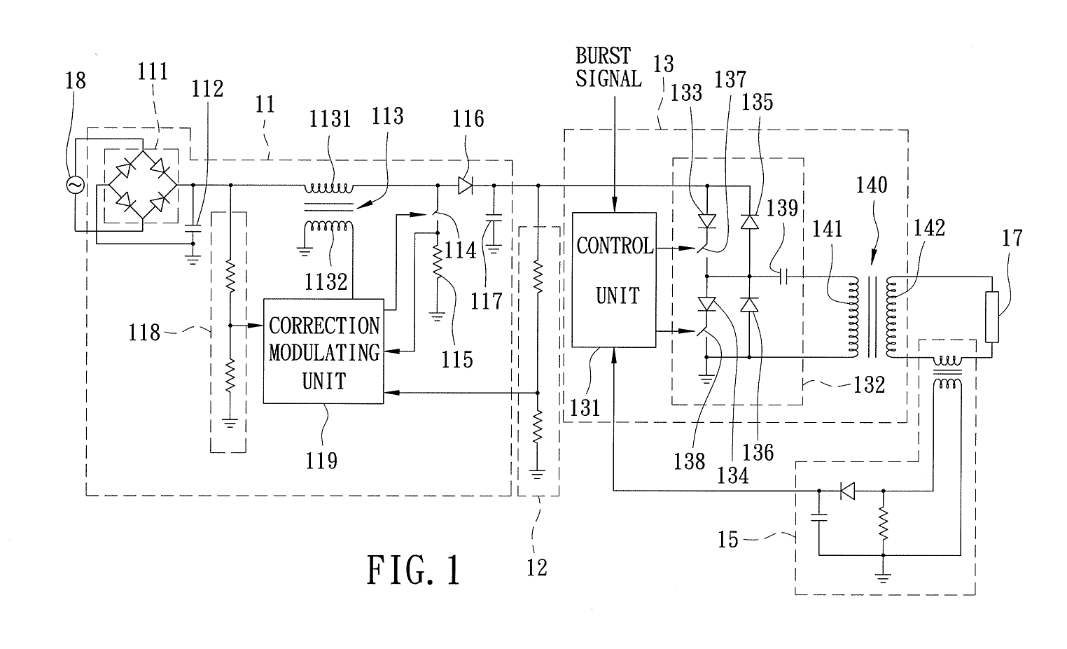

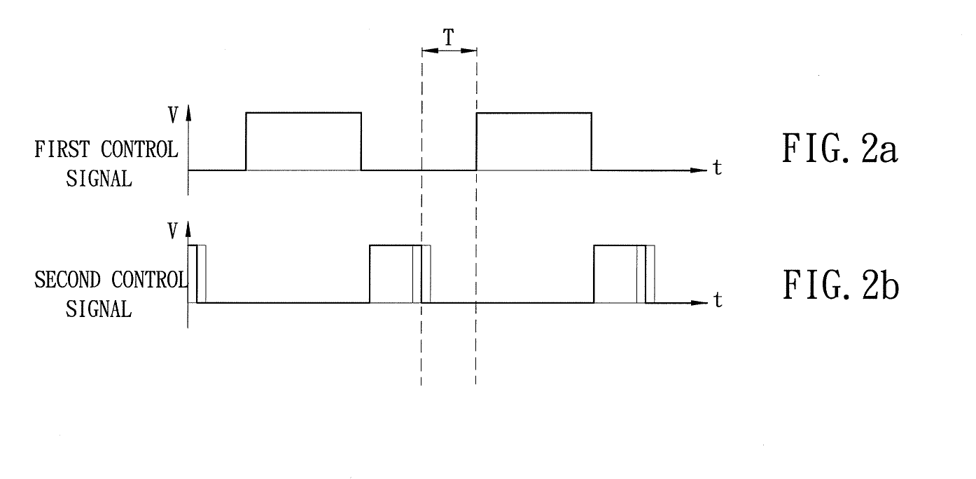

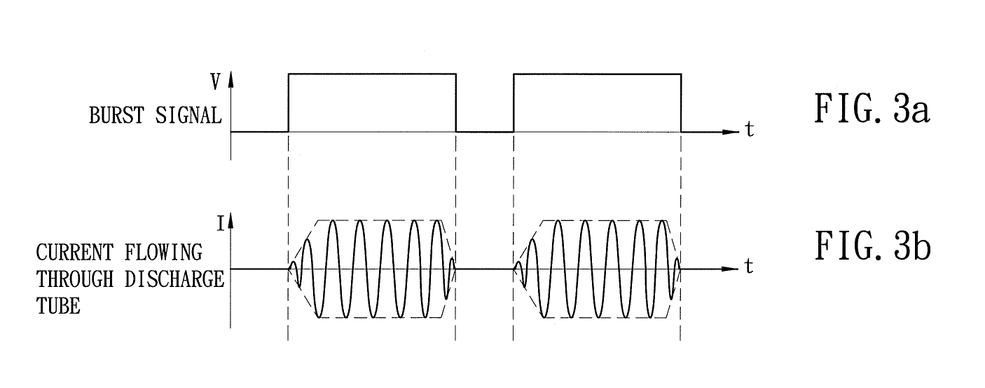

The first voltage converting unit 41 is adapted for converting an AC voltage signal from an external AC power source 48 into a DC voltage signal using pulse width modulation in response to a feedback signal related to the AC driving signal, and outputs the DC voltage signal. In this embodiment, the first voltage converting unit 41 includes a first rectifying and filtering circuit composed of a full-bridge rectifier 411 and a capacitor 412, a step-up transformer 413 with windings 4131, 4132, a second rectifying and filtering circuit composed of a diode 416 and a capacitor 417, a voltage dividing circuit 418, a series connection of a switch 414 and a resistor 415, and a correction modulating unit 419 that have configurations similar to those of the first voltage converting unit 11 shown in FIG. 1. The first voltage converting unit 41 differs from the first voltage converting unit 11 shown in FIG. 1 in that the correction modulating unit 419 generates the control signal for controlling operation of the switch 414 based on the feedback signal, the first reference voltage signal from the voltage dividing circuit 418, the induced voltage signal from the winding 4132 of the step-up transformer 413, and the second reference voltage signal related to the current flowing through the resistor 415.

The voltage detecting unit 42 is coupled to the first voltage converting unit 41 for detecting the DC voltage signal therefrom, and outputs a standard voltage signal based on the DC voltage signal detected thereby.

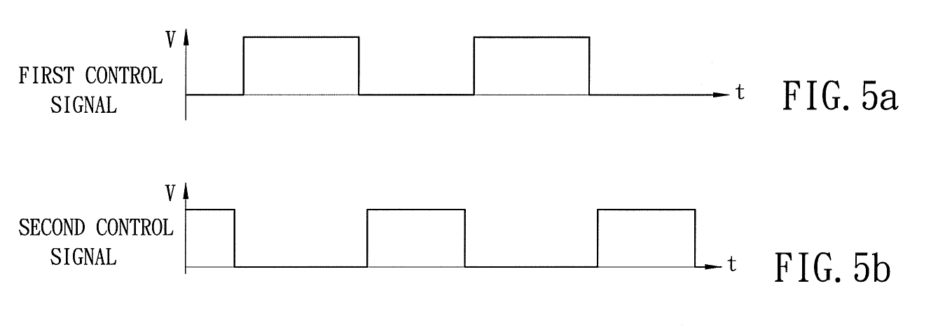

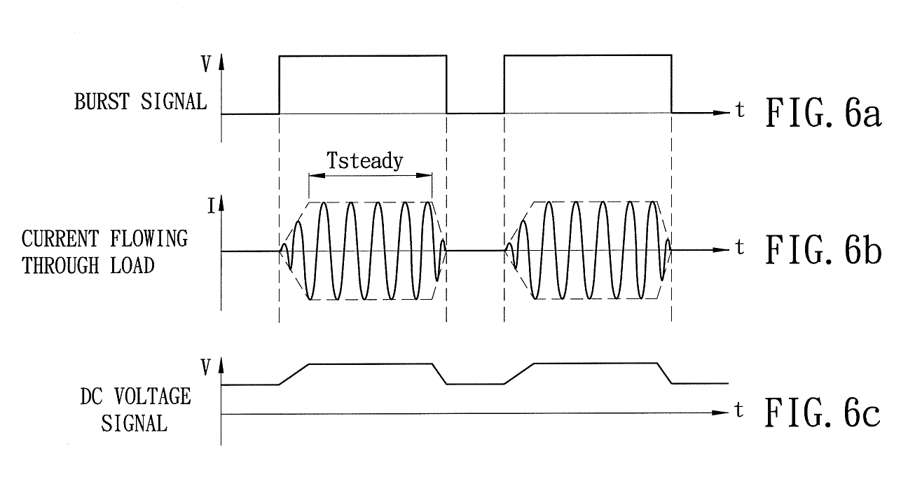

The second voltage converting unit 43 is coupled to the first voltage converting unit 41 for converting the DC voltage signal therefrom into the AC driving signal based on an external burst signal, and is adapted to output the AC driving signal to the load 47. In this embodiment, the second voltage converting unit 43 includes a half-bridge circuit 432, a step-up transformer 440, and a control unit 431. The half-bridge circuit 432 includes four diodes 433, 434, 435, 436, first and second switches 437, 438, and a capacitor 439. The step-up transformer 440 has a primary winding 441 coupled to the half-bridge circuit 432, and a secondary winding 442 adapted to be coupled to the load 47. The control unit 431 generates first and second control signals, as shown in FIGS. 5a and 5b, for controlling respectively the first and second switches 437, 438, and outputs the first and second control signals based on the burst signal, as shown in FIG. 6a, so that the DC voltage signal from the first voltage converting unit 41 is converted into the AC driving signal. The first switch 437 is switched on during high-level periods of FIG. 5a, and the second switch 438 is switched on during high-level periods of FIG. 5b. Preferably, each of the first and second control signals has a fixed pulse width so that the first switch 437 has a fixed duty ratio substantially equal to 50% and that the second switch 138 has a fixed duty ratio ranging from 40% to 50%. As a result, the current flowing through the load 47 can be obtained as shown FIG. 6b, wherein the amplitude of the current is gradually increased to a stable value, thereby preventing overshooting.

The current detecting unit 45 is adapted to be coupled to the load 47 for detecting a current flowing through the load 47, and outputs a current detecting signal corresponding to the current flowing through the load 47.

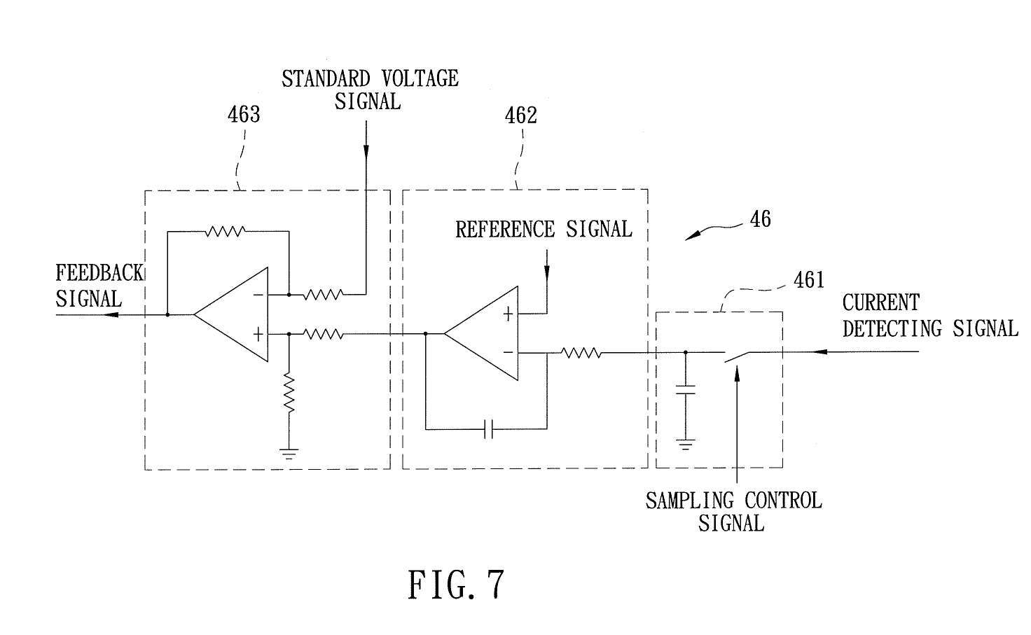

The summing unit 46 is coupled to the first voltage converting unit 41, the voltage detecting unit 42, and the current detecting unit 45, receives the standard voltage signal from the voltage detecting unit 42 and the current detecting signal from the current detecting unit 45, and outputs the feedback signal based on the standard voltage signal and the current detecting signal received thereby. In this embodiment, referring further to FIG. 7, the summing unit 46 includes a sampling unit 461, an integrator 462, and an operational amplifier 463. The sampling unit 461 is coupled to the current detecting unit 45 for sampling the current detecting signal therefrom based on an external sampling control signal generated upon detecting that the current detecting signal has a non-zero stable amplitude, i.e., during a period (T_{steady}) of FIG. 6b, so as to generate and output a sampling signal. The integrator 462 is an inverting integrator in this embodiment, and is coupled to the sampling unit 461 for integrating a difference between a reference signal and the sampling signal from the sampling unit 461 to generate an integrating signal. The operational amplifier 463, such as a differential amplifier, has two input ends coupled respectively to the voltage detecting unit 42 and the integrator 462 for receiving the standard voltage signal and the integrating signal therefrom, and an output end coupled to the first voltage converting unit 41. The operational amplifier 463 generates the feedback signal from a difference between the integrating signal and the standard voltage signal, and outputs the feedback signal at the output end.

In this embodiment, the sampling unit 461 of the summing unit 46 samples the current detecting signal from the current detecting unit 45 upon detecting that the current detecting signal has the non-zero stable amplitude. However, if the sampling unit 461 samples continuously the current detecting signal from the current detecting unit 45 regardless of the amplitude of the current detecting signal, the DC voltage signal outputted by the first voltage converting unit 41 will change with the burst signal, as shown in FIG. 6c.

It is noted that, although the current detecting signal is a voltage signal in this embodiment, in other embodiments, the current detecting signal can be a current signal, a frequency signal or a duty signal, and the configuration of the summing unit 46 will change with the characteristics of the current detecting signal.

In sum, the second switch 438 of the second voltage converting unit 43 has the fixed duty ratio. Due to the presence of the summing unit 46, the DC voltage signal outputted by the first voltage converting unit 41 can be adjusted in response to variation of the current flowing through the load 47. Therefore, the problems encountered in the prior art can be alleviated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A driving device adapted for providing an AC driving signal to a load, comprising:
a first voltage converting unit adapted for converting an AC voltage signal from an external AC power source into a DC voltage signal using pulse width modulation in response to a feedback signal related to the AC driving signal, and outputting the DC voltage signal;
a voltage detecting unit coupled to said first voltage converting unit for detecting the DC voltage signal therefrom, and outputting a standard voltage signal based on the DC voltage signal detected thereby;
a second voltage converting unit coupled to said first voltage converting unit for converting the DC voltage signal therefrom into the AC driving signal based on an external burst signal, and adapted to output the AC driving signal to the load;
a current detecting unit adapted to be coupled to the load for detecting a current flowing through the load, and outputting a current detecting signal corresponding to the current flowing through the load; and
a summing unit coupled to said first voltage converting unit, said voltage detecting unit, and said current detecting unit, receiving the standard voltage signal from said voltage detecting unit and the current detecting signal from said current detecting unit, and outputting the feedback signal based on the standard voltage signal and the current detecting signal received thereby.

2. The driving device as claimed in claim 1, wherein said summing unit generates a sampling signal in accordance with the current detecting signal upon detecting that the current detecting signal has a non-zero stable amplitude, and outputs the feedback signal to said first voltage converting unit based on the sampling signal and the standard voltage signal.

3. The driving device as claimed in claim 1, wherein said summing unit includes:
a sampling unit coupled to said current detecting unit for sampling the current detecting signal therefrom upon detecting that the current detecting signal has a non-zero stable amplitude so as to generate and output a sampling signal;
an integrator coupled to said sampling unit for integrating the sampling signal therefrom to generate an integrating signal; and
an operational amplifier having two input ends coupled respectively to said voltage detecting unit and said integrator for receiving the standard voltage signal and the integrating signal therefrom, and an output end coupled to said first voltage converting unit for outputting the feedback signal.

4. The driving device as claimed in claim 3, wherein:
said integrator is an inverting integrator for integrating a difference between a reference signal and the sampling signal to generate the integrating signal; and
said operational amplifier is a differential amplifier that generates the feedback signal from a difference between the integrating signal and the standard voltage signal.

5. The driving device as claimed in claim 1, wherein said second voltage converting unit includes a half-bridge circuit having first and second switches that are controlled so that the DC voltage signal from said first voltage converting unit is converted into the AC driving signal.

6. The driving device as claimed in claim 5, wherein said first switch has a duty ratio substantially equal to 50%, and said second switch has a duty ratio ranging from 40% to 50%.

7. The driving device as claimed in claim 6, wherein the duty ratios of said first and second switches are fixed.

8. The driving device as claimed in claim 5, wherein said second voltage converting unit further includes:
a step-up transformer having a primary winding coupled to said half-bridge circuit, and a secondary winding adapted to be coupled to the load; and
a control unit for controlling said first and second switches based on the burst signal.

9. A method of providing an AC driving signal to a load, comprising the steps of:
a) generating a current detecting signal corresponding to a current flowing through the load;
b) generating a feedback signal based on the current detecting signal and a standard voltage signal;
c) converting an external AC voltage signal into a DC voltage signal using pulse width modulation in response to the feedback signal, the standard voltage signal being associated with the DC voltage signal; and
d) converting the DC voltage signal into the AC driving signal based on an external burst signal, and supplying the AC driving signal to the load.

10. The method as claimed in claim 9, wherein step b) further includes the sub-steps of:
b-1) detecting whether the current detecting signal generated in step a) has a non-zero stable amplitude;
b-2) upon detecting that the current detecting signal has a non-zero stable amplitude, generating a sampling signal in accordance with the current detecting signal; and
b-3) generating the feedback signal based on the sampling signal and the standard voltage signal.

11. The method as claimed in claim 10, wherein sub-step b-3) includes the sub-steps of:
b-31) integrating the sampling signal generated in sub-step b-2) to generate an integrating signal; and
b-32) generating the feedback signal based on the integrating signal and the standard voltage signal.

12. The method as claimed in claim 11, wherein:
integrating the sampling signal in sub-step b-31) is accomplished using an inverting integrator for integrating a difference between a reference signal and the sampling signal; and
generating the feedback signal in sub-step b-32) is accomplished using a differential amplifier that generates the feedback signal from a difference between the integrating signal and the standard voltage signal.

13. The method as claimed in claim 8, wherein converting the DC voltage signal in step d) is accomplished using a half-bridge circuit having first and second switches that are controlled so that the DC voltage signal is converted into the AC driving signal.

14. The method as claimed in claim 13, wherein the first switch has a duty ratio substantially equal to 50%, and the second switch has a duty ratio ranging from 40% to 50%.

15. The method as claimed in claim 14, wherein the duty ratios of the first and second switches are fixed.
